(19) United States
(12) Patent Application Publication
(10) Pub. No.: US 2004/0081433 A1
(43) Pub. Date: Apr. 29, 2004

(54) DVD business system

(76) Inventor: Phillip T. Stewart, Temple Hills, MD (US)

Correspondence Address: Barnes & Thornburg, Suite 900, 750 17th Street, N.W., Washington, DC, 20006, US

(21) Appl. No.: 10/281,134

(22) Filed: Oct. 28, 2002

(51) Int. Cl. H04N 5/781

(52) U.S. Cl. 386/94; 386/125

(57) ABSTRACT

This invention relates to a secure non-cloning DVD system which provides special benefits so as to entice consumers to purchase one producer's DVD disk over other DVD disks. Among the special features are the ability for a disk user to contact a special website to receive up-dates to the disk, and/or information about data on the disk, and/or information about related disks, and/or the ability to order and pay for material provided by the DVD disk encoder, etc.

### BACKGROUND AND SUMMARY

DVD's have become a common vehicle for presenting audio and visual programs. This invention relates to a secure non-cloning DVD system which provides special benefits so as to entice consumers to purchase one producer's DVD disk over other DVD disks. Among the special features are the ability for a disk user to contact a special website to receive up-dates to the disk, and/or information about data on the disk, and/or information about related disks, and/or the ability to order and pay for material provided by the DVD disk encoder, etc.

By providing a DVD disk with these special features, consumers would be more apt to select the special feature DVD disk for purchase.

The DVD disks can contain: musical performances; moves; sing-a-long tunes; interactive games; other interactive systems such as entertainment, military, sports, business, industrial, governmental, education, medical, etc. programs.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation of the DVD disk of the instant invention showing certain material located in the disk;

FIG. 2 is a schematic system of the logic set-up for the DVD system;

FIG. 3 is a schematic showing of a first varietal system; and

FIG. 4 is a second varietal system.

### DETAILED DESCRIPTION OF THE DRAWINGS

FIG. 1 shows a DVD disk 10 of the invention general containing the following:

visual and auditory material 12,

a lockout code 13,

an encryption code 14,

a computer address input 16,

upgrade software 18,

erasing software 20, and

fee charging software 21.

The major reason for selection of a DVD disk is for its viewable and audio material. E.g. a DVD disk could be encoded with Cole Porter Broadway show musical selections; the latest hits of Michael Jackson; medical surgical instructions and demonstrations for insertion of artificial knees in a patient; use of woodworking power tools; interactive professional football games; how to speak fluent French; how to play roulette; interactive black-jack gambling (where permitted by law); military strategies; local government (personalities, voting records, committee assignments, staff, address, phone numbers, etc.); movies; etc.

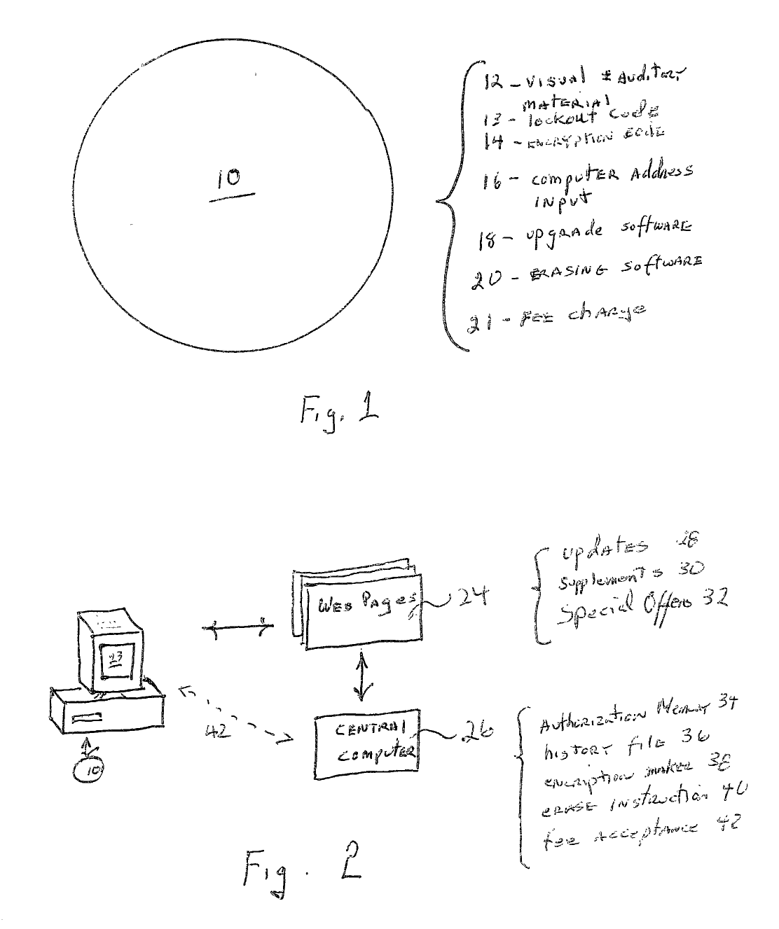

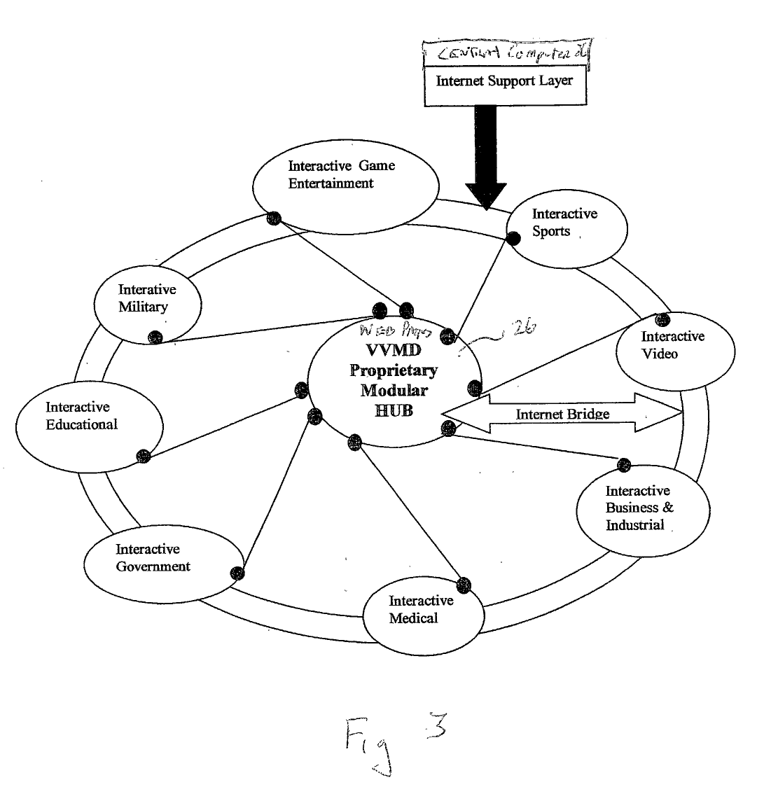

FIG. 2 shows the basic operation logic of the system. A person who purchases a proper DVD disk 10 places the disk into a computer 22 and utilizing the computer address input 16 therein dials up a pre-selected website page(s) 24 which has been created and programmed by the disk producers central computer 26. The web page(s) can offer a menu of up-dates 28 which can be additions or replacement songs for the disk. E.g. if the original disk contained eight Cole Porter musical selections, the menu could provide other musical selections which could be added to, or replace an existing song on the disk.

The menu could include supplements 30 such as: sheet music; cast information; history of the Broadway Show (opening, number of performances, closing, cast changes, etc.); information on other Cole Porter tunes and musicals; revivals including theatre, seating plans, seat costs, cast, seat availability, opening dates, etc.

The web page(s) could also provide a menu of special offers such as: books, videos and articles about Cole Porter, the making of the musical, the making of a movie version; posters for the original musical; other performers presenting the same music (e.g. Ella Fitzgerald presents the Cole Porter Song Book); etc.

When a disk 10 is inserted into computer 22, the disk 10 can be played or contract with the internet for up-dating can be accomplished. The disk 10 is provided with an owner's lockout code 13 area. This feature requires that the disk owner initially put in their own lockout code in that area of the disk 10 to limit access to playing of the disk 10 during its initial placement into the computer 22. This lockout code can be set to prohibit playing of the disk unless the same code is inserted into the computer and the code recognized by the user. The user can also deactivate the lockout code so the disk 10 can be played in a conventional DVD player. This provides the disk 10 owner with a “parental lockout” for selected disks. If, for example, a disk 10 has “x-rated” material, the disk owner doesn't want children to view and/or hear, the owner puts in a lockout code into the lockout code area 13. With such a code, the disk 10 cannot be played in a conventional DVD player or a computer unless, the player inputs the code into the computer to deactivate the lockout feature.

The disk's instruction sheet can provide the internet access code to the desired web page(s) 24, or an automatic address connection code 16 can be provided on the disk itself. In that case a screen would pop up on computer screen 23 which will give a play option or internet option listing various internet providers to select from such as AOL, ATT, etc. The user would merely click on the internet user of choice and the automatic dialing system would connect directly to the web page(s) 24.

When the computer 10 makes contact with the web page(s) 24, the encryption code 14 from the disk is transmitted to the central computer where it is compared to an authorization memory to determine if a proper DVD disk is seeking access. If the disk does not have a proper encryption code, the computer will freeze the web page(s) menu selection process, such as by sending a message when a particular item of a menu is selected such as: “UNAUTHORIZED” as well as denying the computer 22 from receiving updates from selected menu item.

When a particular encryption code requests an item on a menu, the selection is recorded in a history file 36. Should a computer 10 with a DVD disk 10 having a particular encryption code 14 attempt to obtain data from a menu selection 28, 30, 32 from which a DVD disk 10 with the same encryption code 14 previously received data, the history file 36 will note the previous reception and cause the central computer to over-ride the item selected from the menu and have the menu selection cause an erase instruction 40 to be sent to by the web pages 24 menu to the computer 22 which will activate the erasing software 20 on the DVD disk 10 to erase the disk 10. The request for reception of a duplicate menu selection clearly indicates that somehow a cloned duplicate DVD disk 10 has been created and this clone is unauthorized and should be destroyed.

The disks 10 when initially programmed also include well known anti duplication software (not shown) which also activates the erasing software 20 to destroy the authorized disk 10 if duplication is attempted.

The central computer 26 can also send a signal to a connected computer 22 to change the encryption code 14 when a menu selection is requested and downloaded. This will help stop hackers from duplicating authorized disks 10.

A further possible security feature is to have the encryption code contain as many bites as possible. The more bites there are, the more difficult it is for hackers to decipher what the code is. Current technology has a standard 128 bite encryption code and a 512 bite advanced encryption code. The larger the number of bites in the code, the harder for hackers to break the code. Currently, computer types are working on developing 1024 bite encryption codes. In the context of this invention, an encryption code of 128 or 512 bites is currently expected although 1024 bites when developed will be used. Thus, the programming of the disk will allow for use of the 1024 bite codes when developed.

While some updates from menus on the web pages 24 would be free, others would be charged for. For example, in the Cole Porter scenario supra, free updates could include song replacements and additions. Cost items could be: the ordering of tickets to the revival show, ordering, sheet music, obtaining original show posters, etc. When a cost item on a menu is requested, the central computer 26 will cause the fee charge authorization 21 program of the disk to pop-up on the computer screen 23 wherein the user would put in credit card, and mailing or email address information for forwarding of requested information and send that information via a special fee authorization line 42 directly to the central computer 26 where the central computer 26 will process the charge in a manner similar to the processing of charges as is done in most stores.

While the central computer 26 is shown in FIG. 2 as a single computer, it could be a computer system with several computers. A history file of charges for a given disk owner could be kept and special menus with more free benefits provided for repeat cash customers.

The web pages 24 can be continuously up-dated by the central computer to provide, among other things, a listing of new DVD disks produced and/or a catalogue of all existing disks.

If a user wants to purchase a new DVD disk, one option would be for the central computer to direct the user to insert a new blank disk into the computer 22 and for the central computer 26 to send a complete new disk 10 to computer 22 on line 42 (or another connection not shown) after processing a fee authorization charge.

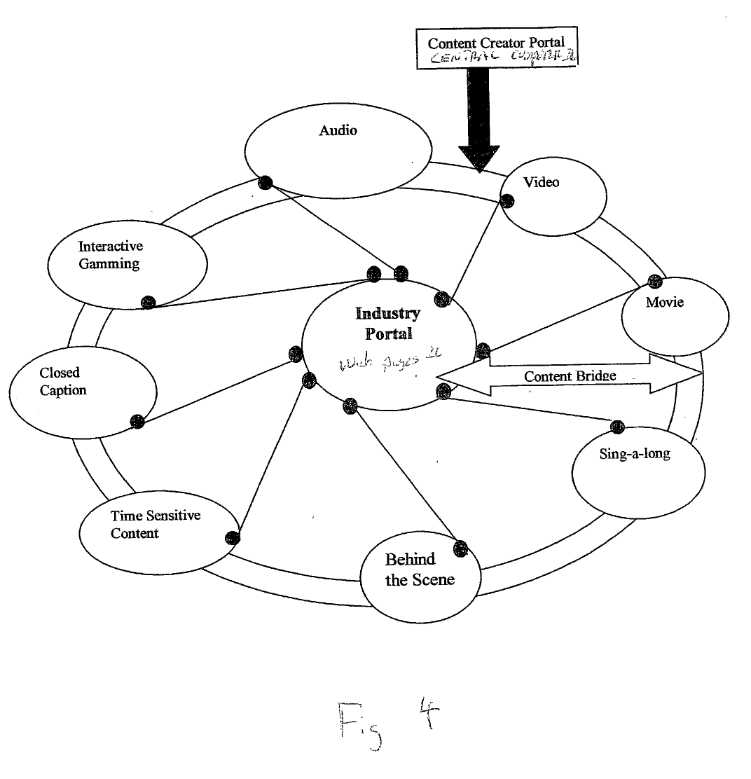

FIGS. 3 and 4 show how multiple different types of DVD disk 10 would access the system web pages 26 which would be created by the central computer 26, while a single computer 26 is shown for simplicity, the central computer 26 could be comprised of a plurality of computers to handle all the information desired.

While the term DVD disk is used, such a term could include high definition disks or CD's. The system provides for VVMD (Virtual Video Media Disk) which provides:

The State-of-the-Art Next Generation Standard
In Entertainment Recording

| | |
|---|---|
| VVMD - Listener Mode | Hear all of the latest (14) new songs |
| | from the artist in any multiple language. |
| VVMD - Music Video Mode | See all the latest (14) music video's |
| | from the artist in any language. |
| VVMD - Movie Mode | Enjoy the latest movie containing the |
| | sound track from the artist in any |
| | language |
| VVMD - Sing Along Mode | Following the bouncing ball and sing |
| | to all the latest (14) releases from |
| | the artist in any language. |
| VVMD - Video Game Mode | Play any and all games on the VVMD |
| | containing the artist in any language. |
| VVMD - Special Feature Mode | Watch special features and behind |
| | the scene interviews on the artist, their |
| | lives, their new products, tour sched- |
| | ules, their charitable and or community |
| | causes, production teams etc. |
| VVMD - Time Sensitive Mode | This mode will only become active and |
| | accessible when the customer loads |
| | the VVMD into their computer. The |
| | amount and frequency of hidden links, |
| | features, information and/or |
| | promotions that can be installed |
| | and tracked are endless. The customer |
| | will be informed as to the time |
| | sensitivity of responding to these offers |
| | or opportunities. The information will |
| | purge itself from the VVMD in |
| | pre-set intervals. |
| VVMD - Closed Caption Mode | For the hearing impaired. |

The web pages 24 can include advertisements for merchandise which the web page owner can sell to other manufacturers.

Education games can be provided wherein a series of questions and answers are provided on the web page and scores (or reports) of correct and incorrect answers are provided. These can be made interactive wherein a user can't go to a second question until the first question is answered correctly.

When a user contacts the web pages and orders changes for its disk 10, the owner will have to give a web address. The central computer will store this address in a memory that also identifies the material on the disk 10. This storage provides a tracking feature for the owner of the web page system. The owner will thus know the computer address of all its customers correlated by disk subject matter once they contact the web pages.

This tracking feature allows the web page owner the ability to send ads announcing new enhancements to selected customers based on the subject matter of their disk. For example, if the web page owner obtains tour information for a particular artist, it can direct that information directly to owners of disks that feature that artist. E.g. say the web page owner obtains a featured interview of a specific artist, the owner has an appropriate limited list of clients to whom it can offer to sell that interview.

Although the present invention has been described and illustrated in detail, it is to be clearly understood that the same is by way of illustration and example only, and is not to be taken by way of limitation. The spirit and scope of the present invention are to be limited only by the terms of the appended claims.

What is claimed:

1. A method for selling DVD discs by utilizing an updating service comprising:
providing a blank DVD disk,
impressing the disk with at least one visual and auditory program,
encoding the disk with an encryption code,
encoding the disk with a software updating program(s),
encoding the disk within an erase program that prohibits reproduction of any portion of the visual and auditory program and causes the disk to be erased if attempts to clone the disk are attempted,
providing at least one website accessible to the disk,
providing the website with a menu of updated visual and auditory material for the DVD disk, and
activating the disk update program to allow for updating at least in part the visual and auditory program from a selected item on the menu on the website upon connection to the website to the disk when a disk with a proper encryption code is recognized by the website, the updating of the disk also replacing the encryption code with a new encryption code.

2. The method of claim 1 wherein a fee charge authorization program is encoded into the DVD, and
the website being provided with a fee charge acceptance program which transmits information from the fee charge authorization program to a central computer installation which utilizes that authorization to bill the DVD disk holder for at least some of the updates.

3. The method of claim 1 wherein a central computer installation can provide updates to web page(s) at the website.

4. The method of claim 3 wherein the web pages are provided with a plurality of menus of DVD updates and wherein the particular update for the DVD disk is selectable by the DVD user.

5. The method of claim 4 wherein the web page(s) are provided with a plurality of DVD updates and wherein the particular update menus for the DVD disk is automatically determined by the encryption code.

6. The method of claim 4 wherein the DVD user can select whether or not to accept the automatically determined update.

7. The method of claim 1 wherein the accessible website senses the encryption code and permits upgrading for a particular upgrade only when the sensed encryption code has not previously been used to obtain that particular upgrade.

8. The method of claim 7 wherein when the website senses that a request for a particular upgrade has been previously requested for that encryption code, the website sends an upgrade signal to the DVD disk erase program which then erases all information on the DVD disk.

9. The method of claim 1 wherein the encryption code is at least a 512 bite code.

10. The method of claim 1 wherein upon selection of the user of a desired update material referenced in the menus of an appropriate web page(s), the update is sent to the user's computer for storage on the disk.

11. The method of claim 10 wherein transmission of the selected updates comes from the website

12. The method of claim 1 wherein upon selection by the user of a desired update, the web page instructs the user's computer to a direct connection with a central computer system which will then connect with the user's computer to provide the appropriate update.

13. The method of claim 1 wherein the disk is provided with a lockout code area, into which the disk owner can insert a code to limit the ability of persons to play the disk.

14. The method of claim 1 wherein the web site is provided with a memory section that records e-mail addresses of disk owners correlated by subject matter of the disk used to access the website.

15. The method of claim 14 wherein the memory can be used to provide a selective inventory of disk owners by subject matter and e-mail address for unrequested sending of appropriate directed advertising and informational material.

16. A DVD disk containing
a visual program;
an audio program;
an encryption code area for reception of an encryption code;
a security program that prohibits reproduction of any portion of the visual and audio programs;
an erase program to erase the visual and audio programs; and
a program that allows updating of any one of the disk's visual program, audio program and encryption code from a remote site when a disk with a proper encryption code is used.

17. The DVD disk of claim 16 wherein the encryption code is at least a 512 bite encryption code.

18. The disk of claim 16 wherein the encryption code area is created so as to be able to accept a 1024 bite encryption code.

19. The disk of claim 16 which also contains a fee charge program which provides a vehicle for a computer user to send fee debit authorization to a remote location for purchasing selected up-dates to be sent to update the program on the disk.

20. The disk of claim 16 wherein the encryption code area is created so as to be able to accept a 1024 bite encryption code.
